(19) United States
(12) Patent Application Publication
(10) Pub. No.: US 2006/0090911 A1
(43) Pub. Date: May 4, 2006

(54) Fertilizer stake boring tool and method

(76) Inventor: Ronald Laramee, Punta Gorda, FL (US)

Correspondence Address: LITMAN LAW OFFICES, LTD, PO BOX 15035, CRYSTAL CITY STATION, ARLINGTON, VA, 22215, US

(21) Appl. No.: 11/297,688

(22) Filed: Dec. 9, 2005

Related U.S. Application Data
(63) Continuation-in-part of application No. 10/879,943, filed on Jun. 29, 2004.

(51) Int. Cl. A01B 1/00

(52) U.S. Cl. 172/371

(57) ABSTRACT

A tool and method for implanting fertilizer stakes. The tool includes a hardened-metal spike that is approximately the size of as a conventional fertilizer stake. The spike is provided with a chiseled-shaped point at its distal end. The proximate end of the spike is welded to the lower surface of a horizontally oriented member. A vertically oriented leg has its lower end attached to the horizontal member. The upper end of the leg is of a T-shaped configuration and forms a cushioned handle member. In use, the spike is pushed into the ground to form a cavity when the force of the user's foot is applied to the planar, upper surface of the horizontal member. If resistance is encountered, the tool can be twisted about its vertical axis, thereby allowing the spike to cut through roots and dislodge small stones. Once the cavity is formed, the spike is withdrawn and a fertilizer stake is easily inserted in the cavity.

### CROSS-REFERENCE TO RELATED APPLICATIONS

This is a continuation-in-part of my prior application Ser. No. 10/879,943 filed Jun. 29, 2004 (pending).

### BACKGROUND OF THE INVENTION

1. Field of the Invention

The present invention generally relates to hand tools. More specifically, the present invention is drawn to a tool and method for assisting in the implantation of fertilizer stakes in the ground.

2. Description of the Related Art

The use of fertilizer stakes has become a popular method for fertilization of trees and shrubs. The usual method for implanting the stakes requires the user to get down on hands and knees and hammer the stakes into the ground. This procedure can be an arduous task for many people, especially the elderly and those with back, leg or knee problems. Further, if the ground is hard or there are roots or rocks imbedded therein, it is sometimes impossible to drive the stakes into the ground without crushing the stakes and negating the fertilization process. The art would certainly welcome a tool that would allow efficient and easy implantation of fertilizer stakes.

There are many tools disclosed in the related art utilized for penetrating the ground for various reasons. Pertinent patented examples of such tools are cited and identified in the accompanying IDS. However, none of the above cited and identified patents, taken either singly or in combination, is seen to disclose a tool and method for implanting a fertilizer stake as will be subsequently described and claimed in the instant invention.

### SUMMARY OF THE INVENTION

The present invention is a tool and method for implanting fertilizer stakes. The tool includes a hardened-metal spike that is approximately the size of as a conventional fertilizer stake. The spike is provided with a chiseled-shaped point at its distal end. The proximate end of the spike is welded to the lower surface of a horizontally oriented member, which member has a planar upper surface. A vertically oriented leg has its lower end attached to the horizontal member. The upper end of the leg is of a T-shaped configuration and forms a cushioned handle member. In use, the spike is pushed into the ground to form a cavity when the force of the user's foot is applied to the planar, upper surface of the horizontal member. If resistance is encountered, the tool can be twisted about its vertical axis, thereby allowing the spike to cut through roots and dislodge small stones. Once the cavity is formed, the spike is withdrawn and a fertilizer stake is easily inserted in the cavity. Accordingly, the instant invention presents a tool assist in the implantation of fertilizer stakes, which tool is efficient and easy to use. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a fertilizer stake boring tool and method according to the present invention.

FIG. 2 is a perspective view of a fertilizer stake boring tool according to the present invention.

FIG. 3 is a front view of a fertilizer stake boring tool according to the present invention.

FIG. 4 is a top view of a fertilizer stake boring, tool according to the present invention.

FIG. 5 is a bottom view of a fertilizer stake boring tool according to the present invention.

FIG. 6 is a partial view showing the handle construction of a fertilizer stake boring tool according to the present invention.

Similar reference characters denote corresponding features consistently throughout the attached drawings.

### DETAILED DESCRIPTION OF THE PREFERRED EMBODIMENTS

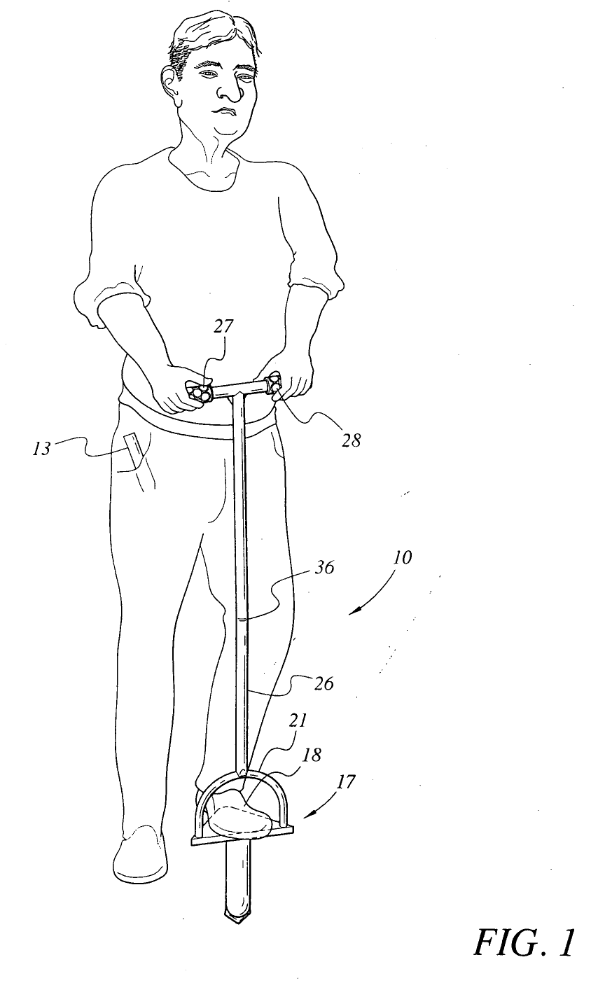

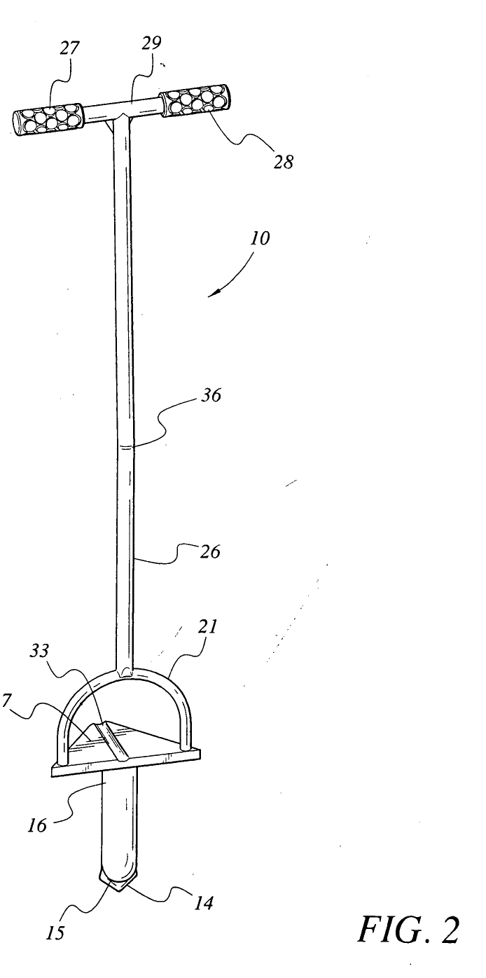

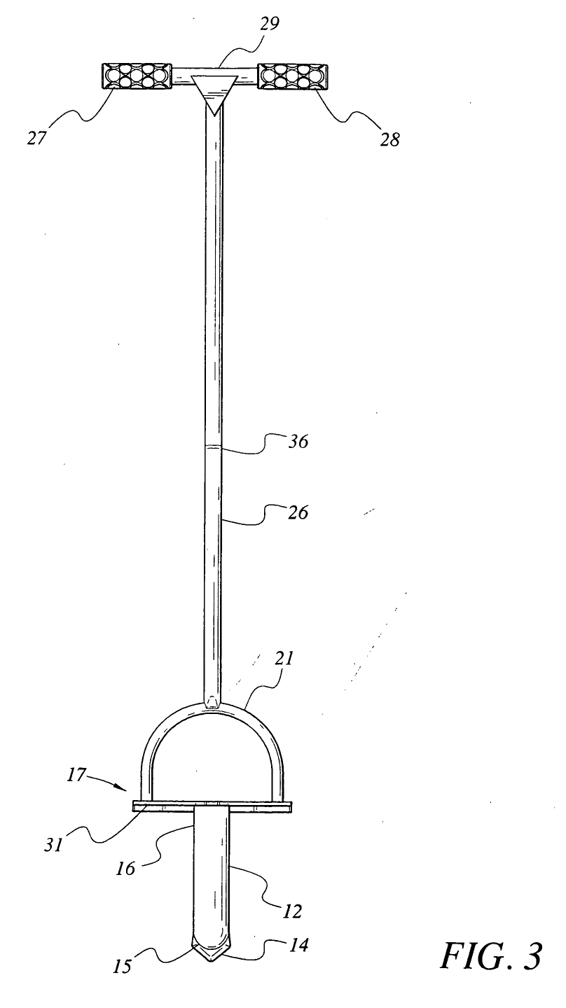

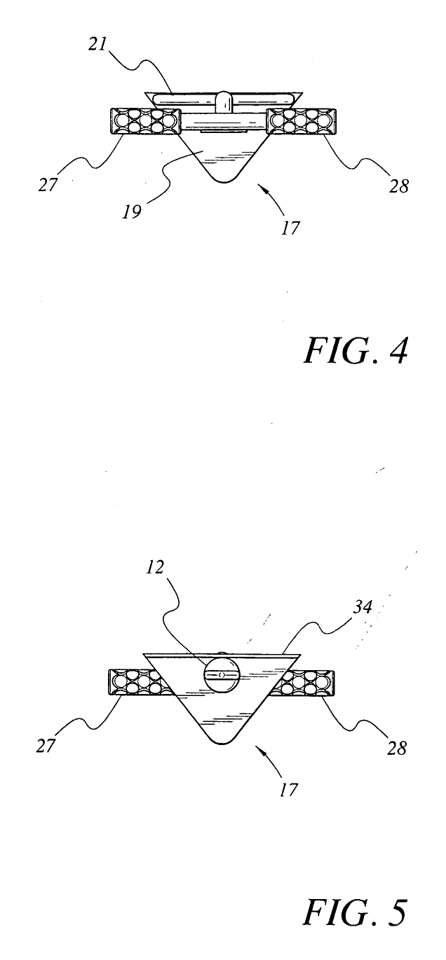

Attention is directed to FIGS. 1-5 of the drawings wherein the tool of the present invention is generally indicated at 10. The tool includes a metal spike 12 having a proximate end 16 and a distal end 15. A chisel-shaped point 14, fabricated from hardened metal, defines the distal or ground engaging end of spike 12. Chisel-shaped point 14 has a trapezoidal configuration. Spike 12 is approximately the same size as a conventional fertilizer stake 13. The proximate end 16 of the spike is attached to the bottom surface 31 of a horizontally oriented member 17. Horizontal member 17 is of triangular configuration having a downwardly extending, rigidity-enhancing flange 34 on the front side thereof. Although shown as triangular, it is recognized that member 17 could assume other configurations, if desired. A vertically oriented leg member 26 is disposed on the upper surface 19 of member 17. The lower end of leg 26 terminates in an open-frame member 21, which member 21 is attached to the upper surface of the platform. The upper end of leg 26 is configured as a T wherein the head of the T forms a handle 29. Cushion grips 27, 28 are disposed on the ends of handle 29 to enhance user comfort. A depression 33 is formed in the upper surface 19 and bisects member 17. Depression 33 functions to strengthen the platform and also enhances friction between the platform and a users foot 18. Although leg 26 can be straight, it has been found that the comfort and effectiveness of the tool is enhanced by placing a slight bend 36 in the leg approximately midway the length of the leg. The leg is bent in a direction away from flange 34 and toward the user. The bend allows the handle 29 to be held against the abdomen of the user so that the torso muscles of the user can assist the arm muscles in twisting the handle 29. This function especially increases the effectiveness of the tool for users with less than average upper body strength. Ideally the bend should be between five and fifteen degrees with the optimum being approximately ten degrees. As presently contemplated, all attachments will be accomplished by welding. It should noted, however that other conventional attachment means may be employed if suitable.

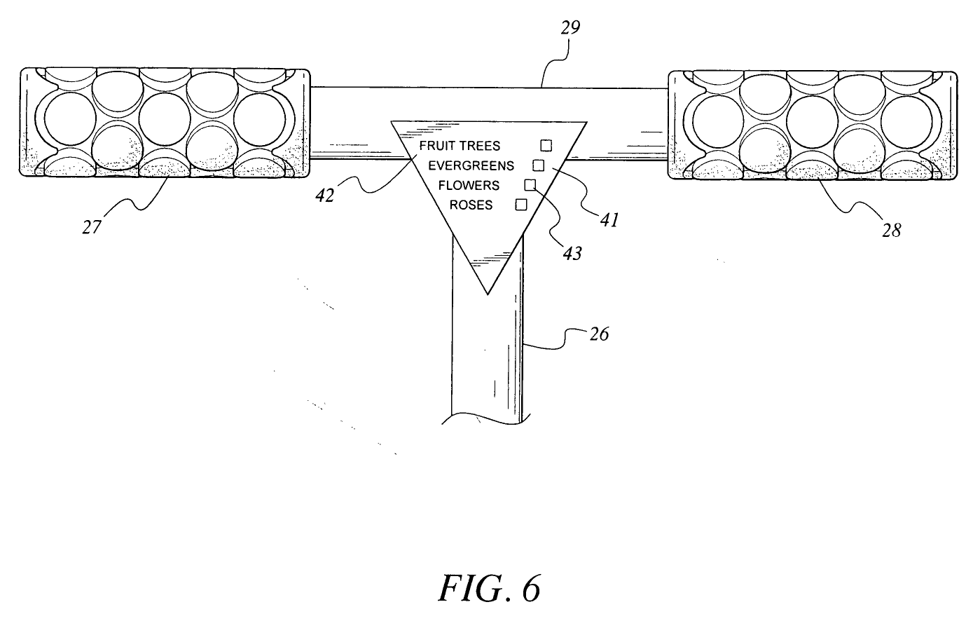

As best seen in FIG. 6, a reinforcing plate 41 is attached to leg 26 and handle 29. Because of different nutritional requirements of various trees, plants, and bushes, color-coded fertilizer stakes of different chemical compositions may be required for effective feeding. The face of plate 41 can be inscribed with a legend 42 and a color patch 43 to indicate the appropriate stake to be employed.

In use, the user places the chisel point of the spike in the position where the fertilizer stake is to be implanted. The downward force of the user's foot on the platform will drive the spike into the ground. If resistance is encountered, twisting the tool about its vertical axis will function to cut through roots and dislodge small stones. When the desired depth is reached, the spike is removed thereby creating a cavity for receiving the fertilizer stake.

It is to be understood that the present invention is not limited to the embodiments described above, but encompasses any and all embodiments within the scope of the following claims.

I claim:

1. A fertilizer stake boring tool comprising:
a horizontal member, said horizontal member having a bottom surface and an upper surface;
a spike, said spike having a proximate end and a distal end, wherein said proximate end is attached to the bottom surface of said horizontal member;
a chisel-shaped point, said chisel-shaped point defining the distal end of said spike;
a leg member said leg member having an upper end and a lower end;
a frame member defining the lower end of said leg member, wherein said frame member is attached to said upper surface of said horizontal member; and
a handle defining the upper end of said leg member.

2. The fertilizer stake boring tool according to claim 1, wherein said horizontal member is triangular shaped.

3. The fertilizer stake boring tool according to claim 1, wherein said leg member has a slight bend midway between said upper end and said lower end.

4. The fertilizer stake boring tool according to claim 1, wherein said upper end of said leg member is configured as a T having a head and wherein the head of said T forms said handle.

5. A fertilizer stake boring tool comprising:
a triangular-shaped horizontal member, said horizontal member having a bottom surface, an upper surface and a front side;
a spike, said spike having a proximate end and a distal end, wherein said proximate end is attached to the bottom surface of said horizontal member;
a chisel-shaped point, said chisel-shaped point having a trapezoidal configuration and defining the distal end of said spike;
a leg member said leg member having an upper end and a lower end;
a frame member defining the lower end of said leg member, wherein said frame member is attached to said upper surface of said horizontal member; and
a handle defining the upper end of said leg member.

6. The fertilizer stake boring tool according to claim 5, wherein a depression bisects said upper surface of said horizontal member.

7. The fertilizer stake boring tool according to claim 5, including a flange depending from the front side of said horizontal member.

8. The fertilizer stake boring tool according to claim 5, wherein said leg member has a slight bend midway between said upper end and said lower end.

9. The fertilizer stake boring tool according to claim 5, wherein said leg member has a slight bend midway between said upper end and said lower end and wherein said bend is away from said front side.

10. The fertilizer stake boring tool according to claim 5, wherein said leg member has a slight bend midway between said upper end and said lower end and wherein said bend is between five and fifteen degrees away from said front side.

11. The fertilizer stake boring tool according to claim 5, wherein said upper end of said leg member is configured as a T having a head and wherein the head of said T forms said handle and including a reinforcing plate mounted to said leg member and said handle.

12. The fertilizer stake boring tool according to claim 5, including color coded indicia inscribed on said reinforcing plate.

13. A method of implantation of a fertilizer stake in the ground, using a tool with a spike having a chisel-shaped point, a triangular shaped platform and a T-shaped handle comprising the steps of:
placing the chisel-shaped point of the spike at a desired location;
placing afoot of a user on the triangular-shaped platform and applying force thereto to drive the spike into the ground;
twisting the tool about a vertical axis of the spike whereby to form a cavity;
removing the spike from the cavity; and
placing the fertilizer stake in the cavity.
